(19) United States
(12) Patent Application Publication
(10) Pub. No.: US 2023/0091695 A1
(43) Pub. Date: Mar. 23, 2023

(54) DEVICE FOR WARNING OF DISTANCE BETWEEN VEHICLES, AND CONTROL METHOD FOR WARNING OF DISTANCE BETWEEN VEHICLES

(71) Applicant: Isuzu Motors Limited, Tokyo (JP)

(72) Inventor: Naoki TAKAHASHI, Fujisawa-shi, Kanagawa (JP)

(73) Assignee: Isuzu Motors Limited, Tokyo (JP)

(21) Appl. No.: 17/794,681

(22) PCT Filed: Jan. 28, 2021
(86) PCT No.: PCT/JP2021/003032

§ 371 Date: Jul. 22, 2022

(30) Foreign Application Priority Data
Jan. 28, 2020 (JP) 2020-011475

(51) Int. Cl. B60W 30/17; B60W 50/14

(52) U.S. Cl. CPC B60W 30/17; B60W 50/14; B60W 2710/18; B60W 2554/802; B60W 2554/804

(57) ABSTRACT

Provided are a device for warning of the distance between vehicles and a control method for warning of the distance between vehicles which can further give a sense of security to an occupant. The device for warning of the distance between vehicles comprises: a preceding vehicle specifying unit which specifies a preceding vehicle that travels in front of a vehicle; and a warning output control unit which, when the preceding vehicle is in a stationary state, outputs a warning of the distance between the vehicles from a warning output unit on the condition that the vehicle is executing adaptive cruise control (ACC).

### TECHNICAL FIELD

The present disclosure relates to a vehicle following distance warning apparatus and a control method for vehicle following distance warning.

### BACKGROUND ART

There has been known an apparatus that specifies a leading vehicle traveling ahead of a vehicle, calculates the distance between the leading vehicle and the vehicle, and gives a warning based on the distance between the vehicles (see, for example, Patent Literature 1).

### CITATION LIST

### Patent Literature

### PTL 1

### Japanese Patent Application Laid-Open No. 2009-151649

### SUMMARY OF INVENTION

### Technical Problem

The conventional apparatus, however, has room for improvement in terms of sense of safety given to a vehicle occupant.

It is an object of the present disclosure to provide a vehicle following distance warning apparatus and a control method for vehicle following distance warning each capable of making a vehicle occupant feel safer.

### Solution to Problem

A vehicle following distance warning apparatus according to an embodiment of the present disclosure includes: a leading vehicle specifying section that specifies a leading vehicle traveling ahead of a vehicle; and a warning output control section that causes, when the leading vehicle is in a stationary state, a warning output section to output a following distance warning on condition that the vehicle be performing adaptive cruise control (ACC).

A control method for vehicle following distance warning according to an embodiment of the present disclosure includes: specifying, by an apparatus mounted on a vehicle, a leading vehicle traveling ahead of the vehicle; and when the leading vehicle is in a stationary state, causing, by the apparatus mounted on the vehicle, a warning output section to output a following distance warning on condition that the vehicle be performing adaptive cruise control (ACC).

### Advantageous Effects of Invention

According to the present disclosure, it is possible to increase convenience of a vehicle following distance warning when a vehicle performs ACC.

### BRIEF DESCRIPTION OF DRAWINGS

FIG. 1 is a block diagram illustrating configurations of a vehicle and a vehicle following distance warning apparatus according to an embodiment of the present disclosure;

FIG. 2 is a schematic diagram illustrating an exemplary distance between a vehicle with the vehicle following distance warning apparatus and a leading vehicle according to an embodiment of the present disclosure; and

FIG. 3 is a flowchart describing an operation procedure of the vehicle following distance warning apparatus according to an embodiment of the present disclosure.

### DESCRIPTION OF EMBODIMENTS

Hereinafter, embodiments of the present disclosure will be described in detail with reference to the accompanying drawings.

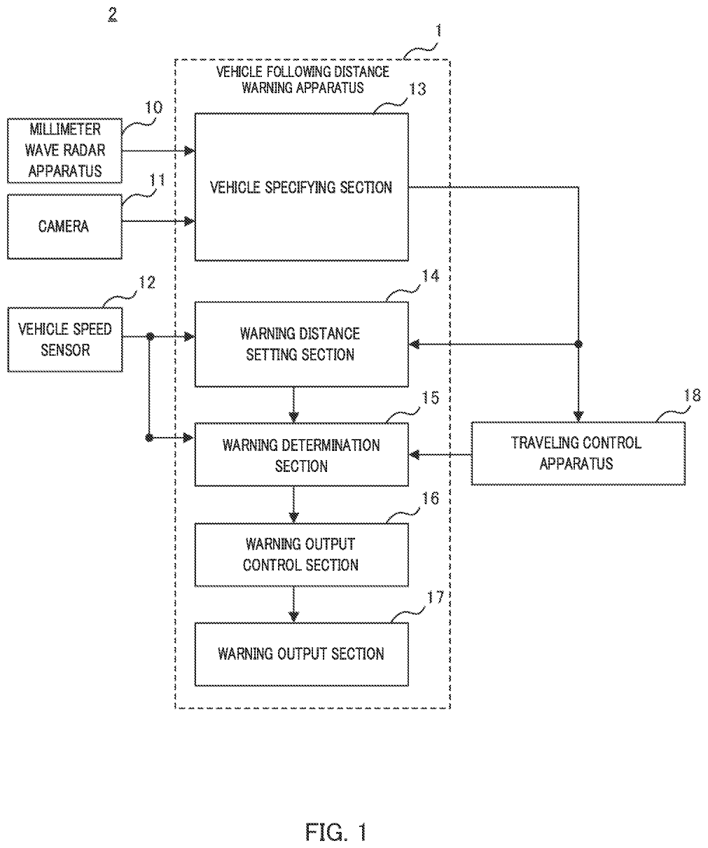

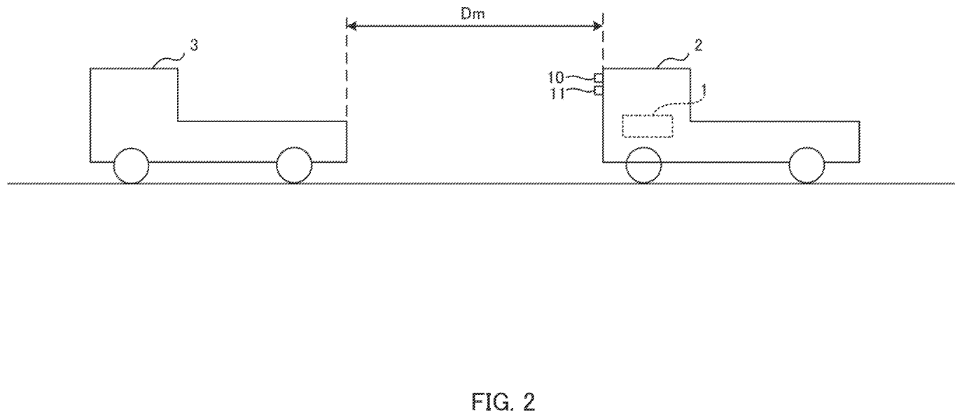

First, vehicle 2 and vehicle following distance warning apparatus 1 according to an embodiment of the present disclosure will be described with reference to FIGS. 1 and 2. FIG. 1 is a block diagram illustrating configurations of vehicle 2 and vehicle following distance warning apparatus 1. FIG. 2 is a schematic diagram illustrating an exemplary distance Dm between vehicle 2 and leading vehicle 3.

Vehicle 2 is, for example, an automobile, and may be a passenger car or a commercial vehicle.

As illustrated in FIGS. 1 and 2, vehicle 2 includes vehicle following distance warning apparatus 1, millimeter wave radar apparatus 10, camera 11, vehicle speed sensor 12 (not illustrated in FIG. 2), and traveling control apparatus 18 (not illustrated in FIG. 2).

Millimeter wave radar apparatus 10 is placed on the front side of vehicle 2 as illustrated in FIG. 2, emits a millimeter-wave radar ahead, and receives its reflected wave. Millimeter wave radar apparatus 10 outputs timing information indicating a transmission timing of the millimeter-wave radar and a reception timing of the reflected wave to leading vehicle specifying section 13 of vehicle following distance warning apparatus 1. Note that millimeter wave radar apparatus 10 may transmit an infrared radar in place of the millimeter-wave radar.

Camera 11 is placed on the front side of vehicle 2 as illustrated in FIG. 2, captures the front of vehicle 2, and outputs the image to leading vehicle specifying section 13 of vehicle following distance warning apparatus 1.

Vehicle speed sensor 12 detects the speed of vehicle 2, and outputs vehicle speed information indicating the speed to warning distance setting section 14 and warning determination section 15 of vehicle following distance warning apparatus 1. A sensor generating pulsed signals proportional to the rotational speed of the axle (not illustrated) of vehicle 2, for example, can be used as vehicle speed sensor 12.

Traveling control apparatus 18 performs adaptive cruise control (ACC), which causes vehicle 2 to follow leading vehicle 3 (see FIG. 2). For example, traveling control apparatus 18 performs the ACC by controlling various actuator groups (not illustrated), such as an acceleration/deceleration actuator, steering actuator, and braking actuator, based on the relative speed of leading vehicle 3 with respect to vehicle 2 (hereinafter, simply referred to as relative speed) and distance Dm between vehicle 2 and leading vehicle 3 in the traveling direction of vehicle 2 (hereinafter, simply referred to as following distance Dm; see FIG. 2). Note that the relative speed and the following distance Dm are calculated by, for example, leading vehicle specifying section 13 of vehicle following distance warning apparatus 1.

Vehicle following distance warning apparatus 1 includes leading vehicle specifying section 13, warning distance setting section 14, warning determination section 15, warning output control section 16, and warning output section 17.

Although not illustrated, vehicle following distance warning apparatus 1 includes, as hardware, a central processing unit (CPU), a read only memory (ROM) storing a computer program, and a random access memory (RAM), for example. The functions of vehicle following distance warning apparatus 1 to be described below are implemented by performing a computer program read from the ROM by the CPU.

Leading vehicle specifying section 13 specifies leading vehicle 3 present in the traveling direction of vehicle 2 based on the timing information received from millimeter wave radar apparatus 10 and the image received from camera 11. Leading vehicle specifying section 13 is capable of specifying leading vehicle 3 when the following distance

Dm is approximately from 1 m to 100 m, for example.

Upon specifying leading vehicle 3, leading vehicle specifying section 13 calculates the relative speed and the following distance Dm. Then, leading vehicle specifying section 13 outputs relative speed information indicating the relative speed and following distance information indicating the following distance Dm to warning distance setting section 14 and traveling control apparatus 18.

Warning distance setting section 14 receives the relative speed information and the following distance information from leading vehicle specifying section 13, and receives the vehicle speed information from vehicle speed sensor 12. Warning distance setting section 14 then sets a warning distance variably in real time based on such information. This warning distance is used as a threshold to determine whether to output a following distance warning.

Subsequently, warning distance setting section 14 outputs warning distance information indicating the warning distance, the relative speed information, and the following distance warning to warning determination section 15.

Warning determination section 15 determines whether the following distance Dm indicated in the following distance information is equal to or less than the warning distance indicated in the warning distance information.

When warning determination section 15 determines that the following distance Dm is equal to or less than the warning distance, warning output control section 16 gives a warning output instruction to warning output section 17.

When the warning output instruction is given from warning output control section 16, warning output section 17 outputs a following distance warning.

The following distance warning may be, for example, an alarm sound from speakers on the right and left doors, or an image on a display provided on an instrument panel of a driver's seat. By outputting the following distance warning in this manner, an occupant in vehicle 2 can recognize that vehicle 2 is approaching leading vehicle 3.

The basic operation of vehicle following distance warning apparatus 1 has been described above; however, vehicle following distance warning apparatus 1 according to the present embodiment further performs a characteristic operation to be described below.

Generally, when a vehicle performing the ACC approaches a stationary leading vehicle, braking is automatically performed (hereinafter, referred to as automatic braking) by traveling control apparatus 18 in order to avoid a collision regardless of the driver's operation, but a following distance warning is not outputted at that time. Even in a case where the driver recognizes that the automatic braking is performed by the ACC, the driver possibly feels anxious when the vehicle actually approaches the leading vehicle.

With this regard, vehicle following distance warning apparatus 1 according to the present embodiment outputs a following distance warning when leading vehicle 3 is in a stationary state, on the condition that vehicle 2 be performing the ACC. In addition, vehicle following distance warning apparatus 1 does not output the following distance warning even when leading vehicle 3 is in a stationary state unless vehicle 2 is performing the ACC. A specific example of this operation will be described below. Note that, in the description below, the above-described operations of leading vehicle specifying section 13, warning distance setting section 14, and warning determination section 15 are not described.

First, warning determination section 15 determines whether leading vehicle 3 is in a stationary state based on the vehicle speed information received from vehicle speed sensor 12 and the relative speed information received from warning distance setting section 14. For example, warning determination section 15 determines that leading vehicle 3 is in a stationary state when the difference between the speed indicated in the vehicle speed information and the speed indicated in the relative speed information is zero.

Note that the concept of the “stationary state” in the above description may include not only the state in which the speed of leading vehicle 3 is zero, but also the state in which the speed of leading vehicle 3 is close to zero. In that case, warning determination section 15 determines that leading vehicle 3 is in a stationary state when the difference between the speed indicated in the vehicle speed information and the speed indicated in the relative speed information is equal to or less than a predetermined threshold (e.g., about several kilometers per hour).

Next, warning determination section 15 determines whether vehicle 2 is performing the ACC. For example, warning determination section 15 determines (may be referred to as “recognizes”) that the ACC is in progress when an indication of the start of the ACC (hereinafter, referred to as “ACC start indication”) has been received from traveling control apparatus 18. The ACC start indication is outputted from traveling control apparatus 18 to warning determination section 15, for example, when the ACC is started.

Warning output control section 16 gives a warning output instruction to warning output section 17 when warning determination section 15 determines that leading vehicle 3 is in a stationary state and vehicle 2 is performing the ACC. This causes warning output section 17 to output a following distance warning. In this case, the warning output instruction may be given to warning output section 17 before the automatic braking is performed by the ACC due to the following distance Dm being equal to or less than the warning distance, for example.

Meanwhile, warning output control section 16 gives no warning output instruction to warning output section 17 when warning determination section 15 determines that leading vehicle 3 is in a stationary state and vehicle 2 is not performing the ACC. This does not cause warning output section 17 to output the following distance warning.

As described above, with vehicle following distance warning apparatus 1 of the present embodiment, the following distance warning is outputted even when vehicle 2 approaches stationary leading vehicle 3 while performing the ACC, so that the driver can recognize in advance that the automatic braking is to be performed. In addition, the driver can prepare for a manual braking operation. This reduces the driver's anxiety and makes the driver feel safer.

The configurations of vehicle following distance warning apparatus 1 and vehicle 2 have been described, thus far.

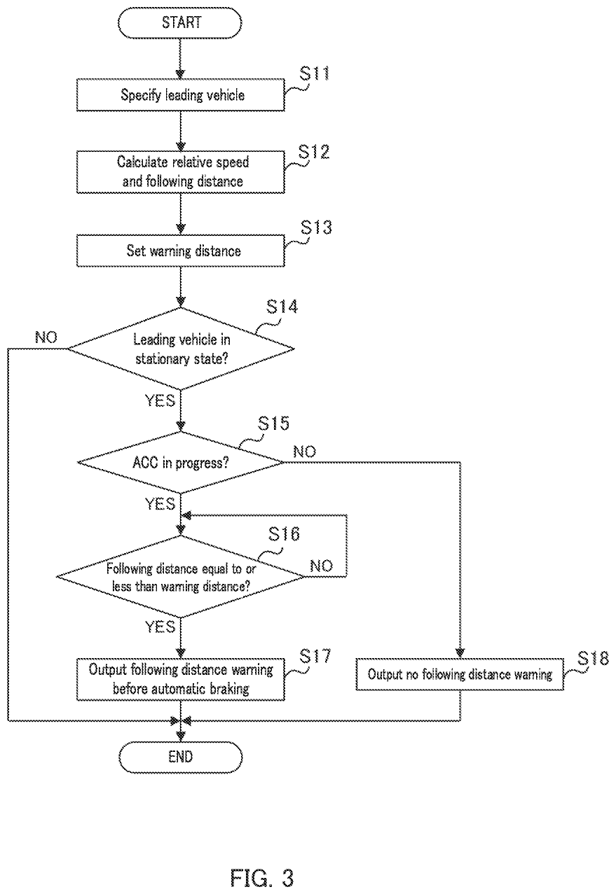

Next, an operation procedure of vehicle following distance warning apparatus 1 will be described with reference to FIG. 3. FIG. 3 is a flowchart describing the operation procedure of vehicle following distance warning apparatus 1. The procedure described in FIG. 3 is initiated when vehicle 2 starts traveling, for example.

In step S11, leading vehicle specifying section 13 specifies leading vehicle 3 present in the traveling direction of vehicle 2 based on the timing information from millimeter wave radar apparatus 10 and the image from camera 11.

In step S12, leading vehicle specifying section 13 calculates the relative speed and the following distance Dm. Then, leading vehicle specifying section 13 outputs the relative speed information and the following distance information to warning distance setting section 14 and traveling control apparatus 18.

In step S13, warning distance setting section 14 sets the warning distance based on the relative speed information and the following distance information from leading vehicle specifying section 13, and the vehicle speed information from vehicle speed sensor 12. Warning distance setting section 14 then outputs the warning distance information, the relative speed information, and the following distance information to warning determination section 15.

In step S14, warning determination section 15 determines whether leading vehicle 3 is in a stationary state based on the vehicle speed information from vehicle speed sensor 12 and the relative speed information from warning distance setting section 14.

When leading vehicle 3 is determined not to be in a stationary state (step S14: NO), the procedure is terminated. Although not illustrated, warning output control section 16 may later instruct warning output section 17 to output the following distance warning when the following distance Dm indicated in the following distance information is equal to or less than the warning distance indicated in the warning distance information.

When leading vehicle 3 is determined to be in a stationary state (step S14:YES), in contrast, the procedure proceeds to step S15.

In step S15, warning determination section 15 determines whether vehicle 2 is performing the ACC based on the presence or absence of the ACC start indication from traveling control apparatus 18.

When the ACC start indication has been received from traveling control apparatus 18, warning determination section 15 determines that the ACC is in progress (step S15: YES).

In this case, the procedure proceeds to step S16.

When no ACC start indication has been received from traveling control apparatus 18, in contrast, warning determination section 15 determines that the ACC is not in progress (step S15: NO). In this case, the procedure proceeds to step S18.

In step S16, warning determination section 15 determines whether the following distance Dm indicated in the following distance information is equal to or less than the warning distance indicated in the warning distance information.

When the following distance Dm is determined not to be equal to or less than the warning distance (step S16: NO), the procedure returns to step S16.

Meanwhile, when the following distance Dm is determined to be equal to or less than the warning distance (step S16: YES), the procedure proceeds to step S17.

In step S17, warning output control section 16 instructs warning output section 17 to output the following distance warning before the automatic braking is performed by traveling control apparatus 18. This causes warning output section 17 to output the following distance warning before the automatic braking.

In step S18, warning output control section 16 does not instruct warning output section 17 to output the following distance warning. This does not cause warning output section 17 to output the following distance warning.

The operation procedure of vehicle following distance warning apparatus 1 has been described, thus far.

Note that the present disclosure is not limited to the embodiment described above, and can be implemented with modifications as appropriate without departing from the spirit of the present disclosure.

The disclosure of Japanese Patent Application No. 2020-011475, filed on Jan. 28, 2020, including the specification, drawings and abstract, is incorporated herein by reference in its entirety.

### INDUSTRIAL APPLICABILITY

A vehicle following distance warning apparatus and a control method for vehicle following distance warning of the present disclosure are useful for output of a following distance warning while ACC is in progress.

### REFERENCE SIGNS LIST

1 Vehicle following distance warning apparatus
2 Vehicle
3 Leading vehicle
10 Millimeter wave radar apparatus
11 Camera
12 Vehicle speed sensor
13 Leading vehicle specifying section
14 Warning distance setting section
15 Warning determination section
16 Warning output control section
17 Warning output section
18 Traveling control apparatus

1. A vehicle following distance warning apparatus, comprising:
a leading vehicle specifying section that specifies a leading vehicle traveling ahead of a vehicle; and
a warning output control section that causes, when the leading vehicle is in a stationary state, a warning output section to output a following distance warning on condition that the vehicle be performing adaptive cruise control (ACC).

2. The vehicle following distance warning apparatus according to claim 1, wherein the warning output control section causes the warning output section to output the following distance warning when a distance between the vehicle and the leading vehicle is equal to or less than a warning distance.

3. The vehicle following distance warning apparatus according to claim 1, wherein the warning output control section causes the warning output section to output the following distance warning before automatic braking is performed by the ACC.

4. A control method for vehicle following distance warning, comprising:
specifying, by an apparatus mounted on a vehicle, a leading vehicle traveling ahead of the vehicle; and
when the leading vehicle is in a stationary state, causing, by the apparatus mounted on the vehicle, a warning output section to output a following distance warning on condition that the vehicle be performing adaptive cruise control (ACC).

5. The control method for vehicle following distance warning according to claim 4, wherein the following distance warning is outputted when a distance between the vehicle and the leading vehicle is equal to or less than a warning distance.

6. The control method for vehicle following distance warning according to claim 4, wherein the following distance warning is outputted before automatic braking is performed by the ACC.
